(19) United States
(12) Patent Application Publication
(10) Pub. No.: US 2014/0359440 A1
(43) Pub. Date: Dec. 4, 2014

(54) SHUFFLE FUNCTIONALITY FOR A MEDIA PLAYER

(71) Applicant: Justin Tipton, Austin, TX (US)

(72) Inventor: Justin Tipton, Austin, TX (US)

(21) Appl. No.: 13/906,919

(22) Filed: May 31, 2013

(51) Int. Cl. G06F 3/0482

(52) U.S. Cl. CPC G06F 3/0482
USPC 715/716

(57) ABSTRACT

A computer implemented method is disclosed for identifying a selection of a media category and identifying media content for the selected media category. The method also includes activating a shuffle option for the media category, applying a categorical unit to the media category, and playing the media content for the selected media category based on the applied categorical unit.

### BACKGROUND OF THE INVENTION

Modern computers are capable of retrieval, storage, manipulation, display, and transmission of media files. Conventional computers include tablets, laptops, desktops, servers, kiosks, television sets, projectors, and handheld form factor devices including smartphones. Each of these computers typically includes one or more processors, storage devices, network interfaces, displays, human-computer interfaces, and operating systems that serve as an interface between application software and the hardware of the computer. Storage devices include computer-readable medium that contains software instructions executed by the processor of the computer.

Conventional media files include audio, video, graphic, document, and other files that store relevant media data. Exemplars of audio media include MP3, AAC, AIFF, WMA, and WAV file formats. Exemplars of video media include MP4, MOV, AVI, WMV, and FLV file formats. Exemplars of graphic media include JPG, PNG, IMG, GIF, TIF, and BMP file formats. Exemplars of documents include TXT, RTF, DOC, WPD, and PDF file formats. Exemplars of other files include HTML and XML files.

Recent trends in modern computers have focused on portable computing devices and more specifically, portable computing devices capable of performing multiple functions. Examples of portable computing devices capable of performing multiple functions include cell phones, media players, and the like.

Portable computing devices have operating systems and may run many different types of applications. One example of an application that is commonly run on portable computing devices is a media player. Media players display various types of content to users such as, for example, artist names, album names, video names, playlists, etc. The user may use various aspects of the media player to play, display, organize, or otherwise manipulate content.

### BRIEF SUMMARY OF THE INVENTION

According to one aspect of one or more embodiments of the present invention, a computer implemented method is disclosed for identifying a selection of a media category and identifying media content for the selected media category. The method also includes activating a shuffle option for the media category, applying a categorical unit to the media category, and playing the media content for the selected media category based on the applied categorical unit.

According to another aspect of one or more embodiments of the present invention a non-transitory computer-readable medium comprising software instructions that, when executed by a processor, performing a method including identifying a selection of a media category and identifying media content for the selected media category. The method also includes activating a shuffle option for the media category, applying a categorical unit to the media category, and playing the media content for the selected media category based on the applied categorical unit.

According to another aspect of one or more embodiments of the present invention a computing device has a display, a processor, a memory, and one or more programs, wherein the one or more programs are stored in the memory and configured to be executed by the processor, the one or more programs include instructions for performing a method including identifying a selection of a media category and instructions for identifying media content for the selected media category. The device also includes instructions for activating a shuffle option for the media category, instructions for applying a categorical unit to the media category, and instructions for playing the media content for the selected media category based on the applied categorical unit.

Other aspects of the present invention will be apparent from the following description and claims.

### BRIEF DESCRIPTION OF THE DRAWINGS

FIG. 1 is a schematic representation of a portable computing device according to embodiments of the present disclosure.

FIG. 2 is a schematic representation of a portable computing device running a media manipulation program according to embodiments of the present disclosure.

FIG. 3 is a schematic representation of a portable computing device running a media manipulation program with an artist media category selected according to embodiments of the present disclosure.

FIG. 4 is a schematic representation of a portable computing device running a media manipulation program with an album media category selected according to embodiments of the present disclosure.

FIG. 5 is a schematic representation of a portable computing device running a media manipulation program with a song media category selected according to embodiments of the present disclosure.

FIG. 6 is a schematic representation of a portable computing device running a media manipulation program with a playlist media category selected according to embodiments of the present disclosure.

FIG. 7 is a schematic representation of a portable computing device running a media manipulation program with a folder media category selected according to embodiments of the present disclosure.

FIG. 8 is a schematic representation of a portable computing device running a media manipulation program with a podcast media category selected according to embodiments of the present disclosure.

FIG. 9 is a schematic representation of a portable computing device running a media manipulation program with a genre media category selected according to embodiments of the present disclosure.

FIG. 10 is a schematic representation of a portable computing device running a media manipulation program with a video media category selected according to embodiments of the present disclosure.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

Portable computing devices, such as media players and cell phones have become common ways for users to manipulate media while not in front of a typical computer. Users may play content, organize content, download additional content, and perform various other features on portable computing devices that involve the use of media.

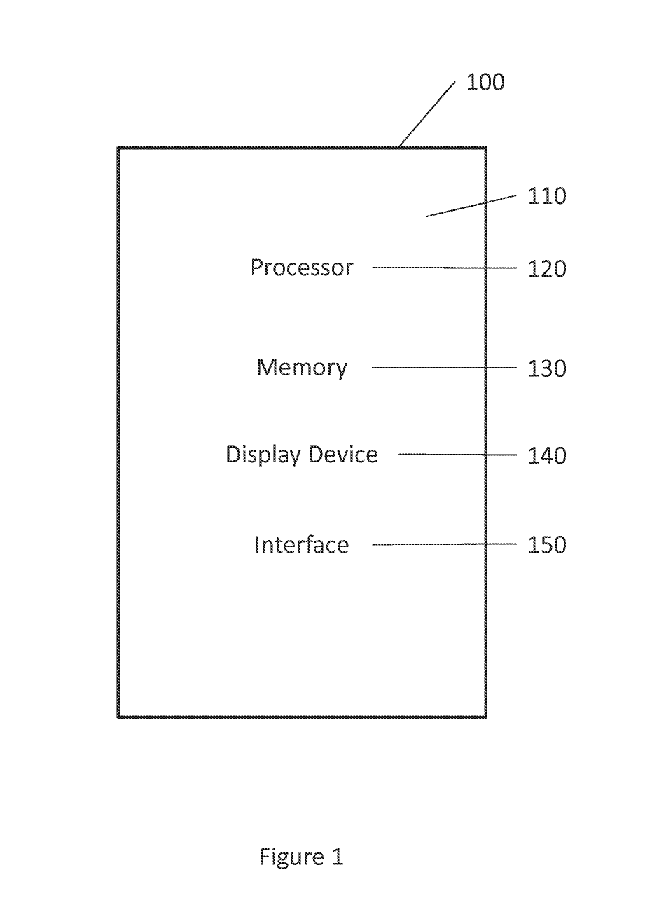

Referring to FIG. 1, a schematic representation of a portable computing device is shown. As illustrated, portable computing device 100 includes a touch screen 110. The portable computing device 100 also includes a processor 120, a memory 130, a display device 140, and an interface 150. During operation, instructions for performing particular actions, such as starting or using programs, i.e., applications, may be stored on memory 130 and accessed by processor 120. After accessing a stored program, portable computing device 100 may include instructions stored in memory 130 to use display device 140 to display information to a user. The information that is displayed to the user may be displayed on the display device 140. In addition to displaying information on the display device 140, the interface 150 may be used by the user to perform particular actions on portable computing device 100. For example, when interface 150 includes a touch screen 110, the user may manipulate portable computing device 100 to access various programs. Specific examples of programs that may be used by a user are explained in detail below.

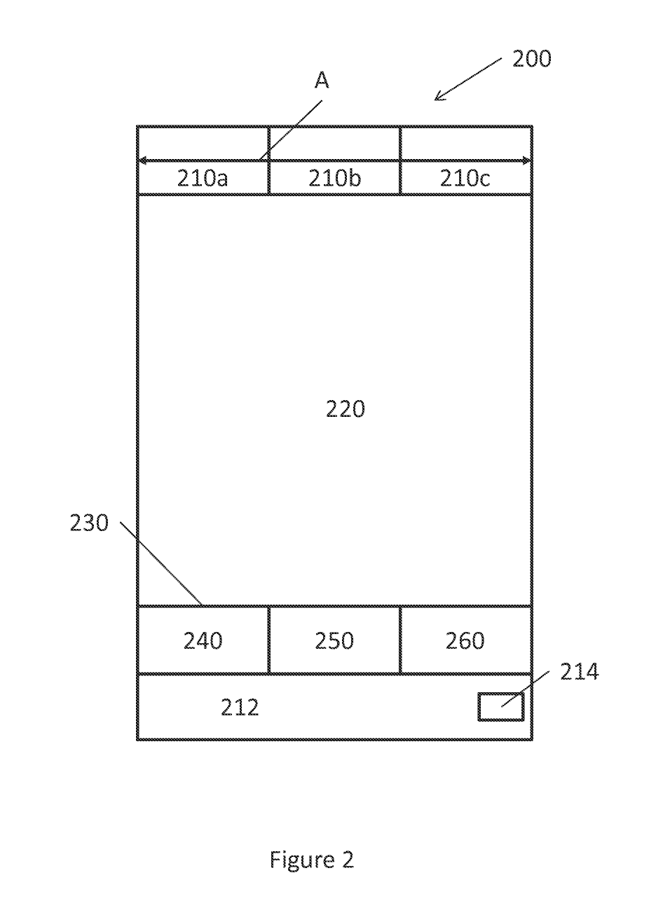

Referring to FIG. 2, a schematic representation of a portable computing device displaying a program according to embodiments of the present disclosure is shown. In this embodiment, portable computing device 200 is illustrated running a media manipulation program. Upon starting the program, portable computing device shows a plurality of media categories 210, as illustrated a first media category 210a, a second media category 210b, and a third media category 210c. Those of ordinary skill in the art will appreciate that various types of media categories may be present including, for example, an artist, an album, a song, a playlist, a folder, a podcast, a genre, and a video. Depending on the requirements of the program and/or the media manipulation operation, the number of media categories that are displayed at any given time may vary. For example, three media categories 210 are displayed in FIG. 2; however, in other embodiments, one, two, four, five, or more media categories 210 may initially be displayed. In still other embodiments, the media manipulation program may not display media categories 210 upon startup. Rather, the user may make a selection that causes the display of media categories 210.

In certain embodiments, there may be more media categories 210 than can reasonably be displayed on portable computing device at one time. In such a circumstance, the user may access additional media categories, such as media categories four and/or five, by sliding a finger across the touch screen laterally across media categories 210 in direction A.

Initially, upon starting the media manipulation program, the media categories 210 may be displayed without any content being displayed in content section 220 of the display. In other embodiments, media content may initially be displayed in content section 220 based on one or more preselected media categories 210. In such an embodiment, the program may display the last viewed media content, a predetermined media content, a random media content, or a suggested media content. In still other embodiments, the program may display a splash screen in the display section until a user selects a desired media content and/or media category 210.

Media manipulation program may also include a currently playing section 212. Currently playing section 212 may display information about the media that is currently playing, such as an artist name, album name, time remaining on the selection, etc. Currently playing section 212 may further include a pause button (not specifically shown), which a user may access in order to temporarily pause the playback of a selected media. Currently playing section 212 may also include an option selector 214. Option selector 214 may allow a user access to additional features, such as, for example, settings, equalizers, search functions, help functions, rating functions, etc.

Media manipulation program further includes a control panel 230. In this embodiment, control panel 230 may include various functionality such as a play button 240, a shuffle button 250, and a media selection button 260. The play button 240 may be selected by a user to play media content from one of a preselected media category 210. Similarly, the shuffle button 250 may be selected by a user to play and shuffle media content within a preselected media category 210. The media selection button 260 may be selected in order to specifically select particular media content. Media selection button 260 may thus be selected by a user to bypass the media categories 210 during media selection.

The display of the shuffle button 250 may vary depending on the media category 210 that is selected. For example, the icon used for the shuffle button 250 may change depending on whether first media category 210a, second media category 210b, third media category 210c, etc., is selected. By varying the display of the shuffle button 250, such as by modifying an icon, the user may receive a visual cue as to which media category is being shuffled.

During operation of the media manipulation program, the control panel 230 may be substantially static on the display. More specifically, as a user accesses various aspects of the media manipulation program, such as selecting one or more media categories 210, the control panel 230 may be substantially constantly displayed to the user. For example, if a user selects first media category 210a as content is updated in content section 220, the control panel 230, or at least aspects of control panel may stay the same, i.e., displaying play button 240, shuffle button 250, and media selection button 260. The user may then select second media category 210b. During the selection of second media category 210b, the content in the content section 220 may change, but the control panel 230, or at least aspects of control panel may stay the same, i.e., displaying play button 240, shuffle button 250, and media selection button 260.

In certain embodiments, only aspects of control panel 230 may remain static during use of the media manipulation program by a user. For example, in certain embodiments, play button 240 and shuffle button 250 may remain static, while media selection button 260 may be updated with new or different functionality. In other embodiments, only a single aspect of control panel 230 may remain static, such as, for example, shuffle button 250.

In certain embodiments, shuffle button 250 may provide additional functionality. As a user selects a media category 210 the shuffle button 250 may include functionality to only shuffle media content from within the selected media category 210. For example, if a user selects first media category 210a, media content may be updated in content section 220. If the user then accesses shuffle button 250, the media manipulation program is instructed to only shuffle media content from within first media category 210a. If a user then selects second media category 210b, media content may be updated in content section 220. If the user then accesses shuffle button 250, the media manipulation program is instructed to only shuffle media content from within second media category 210b. Thus, rather than the shuffle button 250 shuffling all media content accessible by media manipulation program, the shuffle button 250 shuffles media content from a selected media category 210

To further explain functionality of the shuffle button 250, if the first media category 210a selected is an artist, the content section may display various artists in a list. If a user then selects the shuffle option, the media manipulation program may randomly choose songs by a particular artist. In certain embodiments, the shuffle option may thus be selected by a user such that media manipulation program randomly selects an artist and plays the collection of music from the random artist to completion and then proceeds to select another random artist and plays only the files by that artist, and repeats this process until all artists have been played. Specifically, when the shuffle button is pressed a new playlist is generated where each artist has all songs in chronological order.

In certain embodiments, shuffle button 250 may provide additional functionality. Upon selection of shuffle button 250, the media manipulation program may access a previously defined categorical unit for a particular media category 210. A categorical unit may include a specific predefined order of operation for playing media within a particular selected media category 210. Examples of categorical units may include, for example, an alphabetic unit, a date unit, a date range unit, a time unit, a numerical unit, a classification unit such as artist, album, composer, a stylistic unit such as genre or tempo, etc. In applying a specific categorical unit, media manipulation program may identify a categorical unit for a particular media category 210 and then play media in the media category 210 based on the defined categorical unit. Additionally, in certain embodiments, the media played from the specific media category 210, to which a categorical unit is applied, may be played randomly from within the selected media category 210. In certain embodiments, in addition to top tier categorical units, secondary categorical units may also be applied. For example, a top tier categorical unit may be a genre. In such an embodiment, secondary or sub categorical units may include artists, albums, songs, etc. One example of such an application of categorical units may include an initial, top tier, categorical unit of genre, a secondary categorical unit of artists, another secondary categorical unit of albums, and yet another secondary categorical unit of songs. In this embodiment, after applying the top tier categorical unit of genre, media manipulation program may apply the secondary categorical units of artists, albums, and songs to the genre, such that the genre is composed of artists, which are composed of albums, which are composed of songs.

For example, if a user selects the media category 210 of albums, and then selects the shuffle option 250, the media manipulation program may apply a predefined categorical unit to the media category 210 before shuffling the media within the selected media category 210. In one embodiment, the categorical unit may be a date unit, in which media from within the category are grouped to play media from newest to oldest based on the categorical date unit. In such an embodiment, the media manipulation program may thus shuffle media by album from the newest album to the oldest album or alternatively, may play media from the oldest album to the newest album, based on the previously defined specifics of the categorical unit. Thus, during a shuffle 250 operation, media manipulation program may randomly select a date unit as a categorical unit, and apply the categorical unit in order to play media from within the selected media category 210 in a particular order, such as a randomly selected order. In another embodiment, an alphabetic categorical unit may be defined for an album. In such an embodiment, upon selection of the shuffle option 250, the media manipulation program may apply the categorical unit of alphabetic to the media category 210 of albums. In this embodiment, the media manipulation program may then play media from within the media category album in a predefined alphabetical order, e.g., albums may be played based on the first letter in the album name. Additionally, during a shuffle 250 option, the media manipulation program may randomly select the categorical unit of alphabetic and play media from within the selected media category 210.

In certain embodiments, the categorical unit may also be applied to play media randomly from within specific media categories 210. For example, in the alphabetic categorical unit 210 explained above, the media manipulation program may initially randomly choose to apply the categorical unit of alphabetic to the selected media category 210. In this embodiment, media manipulation program may apply the categorical unit 210 alphabetic to select a particular letter, e.g., “A”, “G”, “X”, etc. If the media manipulation program randomly selects the letter “A”, all albums that start with the letter “A” are played before moving on to albums that start with a different randomly selected letter.

In another embodiment, a categorical unit of date may be applied to a particular media category 210. In such an embodiment, the media manipulation program may randomly select to play media with a media category based on a randomly selected date. For example, if the randomly selected date of 2005 was selected, all albums would be played having a release date of 2005 before moving on to another randomly selected date.

As an additional example of random shuffling based on a categorical unit, the media manipulation program that is shuffling based on the categorical unit date range may shuffle all albums according to date from newest to oldest. In such an embodiment, if the newest albums are from the year 2010, all albums from 2010 may be randomly shuffled and played before the media manipulation program plays albums from 2009, and so on.

In still other embodiments, multiple categorical units may be applied to a specific shuffle option 250. For example, in certain embodiments a first categorical unit of genre may be selected. Thus, media manipulation program will first randomly select genre from within the genre categorical unit. Because a genre is a collection of artists that has a collection albums that includes a collection of songs, secondary or sub categorical units may then be applied when determining which media to play. In one embodiment, after initially grouping the media by the categorical unit of genre, media manipulation program may apply a secondary categorical unit of artists. Applying the secondary categorical unit of artists will then randomly select an artist from within the previously selected genre and play all of the artist's songs to completion before moving on to another artist. Additionally, after all media from all artists within the selected genre has been played, media manipulation program may play media from another randomly selected genre. Media manipulation program may then apply the secondary categorical unit of artist to play songs from a random artist from within the randomly selected top tier categorical unit of genre. In still another embodiment, additional levels of secondary or sub categorical units may be applied. For example, after media is grouped by the top tier categorical unit of genre and a random genre is selected, a secondary categorical unit of artist may be applied to randomly select an artist from within the previously selected genre. After the application of the secondary categorical unit, another secondary categorical unit may be applied, such as a categorical unit of album. In such an embodiment, the media manipulation program may randomly select an album by the selected artist, and play all songs within the randomly selected album before playing a second album by the artist.

Those of ordinary skill in the art will appreciate that multiple levels of categorical units may be applied by media manipulation program in order to shuffle media. For example, in certain embodiments, the media manipulation program may only apply a top tier categorical unit when shuffling media. In still other embodiments, media may be shuffled according to top tier and secondary categorical units. In certain embodiments, one, two, three, or more secondary categorical units may be applied in a particular shuffle option. The number of categorical units applied may vary according to the desires of the user or as may be randomly selected by the media manipulation program. For example, in certain embodiments, the media manipulation program may always apply the same number of categorical units when performing a shuffle operation. In other embodiments, the number and order of categorical units applied may change randomly. In still other embodiments, a user may select the specific categorical units applied, either in number, kind, or both, as well as the order of the application of the selected categorical units.

Those of ordinary skill in the art will appreciate that a categorical unit may be predefined within the media manipulation program or may be defined by a user. Additionally, multiple levels of categorical units may be applied to a particular media category 210. For example, each shuffle option 250 may apply a specific categorical unit for a particular selected media category 210. Thus, first media category 210a may have a different base applied categorical unit than second media category 210b. In certain embodiments, the same categorical unit may be applied to all media categories 210, or alternatively, a user may define specific categorical units for each media category 210.

Additional examples of categorical units for particular media categories 210 are discussed in detail below. Those of ordinary skill in the art will appreciate that while certain categorical units are discussed in detail herein, the categorical units discussed are not a limit to the number or types of categorical units that may be applied by media manipulation program or defined by a user. Additionally, while the application of one or two categorical units for a specific media category 210 are explicitly discussed above, additional categorical units, e.g., three, four, or more, may be used for a single shuffle option 250.

In additional embodiments, mixed categorical units may be applied during a shuffle 250 operation. For example, both genres and albums may appear within the same content view 220. Upon selection of a shuffle 250 operation by a user a random genre or album may be selected and played to completion before the next random genre or album is selected and played to completion. In such an embodiment, for example, a user may view both genres and albums in content view 220. When the user selects the shuffle 250 option, the media manipulation program randomly selects either a random genre or a random album. If the random genre selected is rock music, the media manipulation program would then play all rock music before moving on to another randomly selected genre or album. If the media manipulation program instead selects a random album, the entire album is played before moving on to another randomly selected genre or album.

Additional aspects and functionality of the media manipulation program are discussed below with respect to specific user selections. Those of ordinary skill in the art will appreciate that specific aspects and functionality of media manipulation program may only be present in specific embodiments, while other aspects and functionality may be present in substantially all embodiments of the present disclosure.

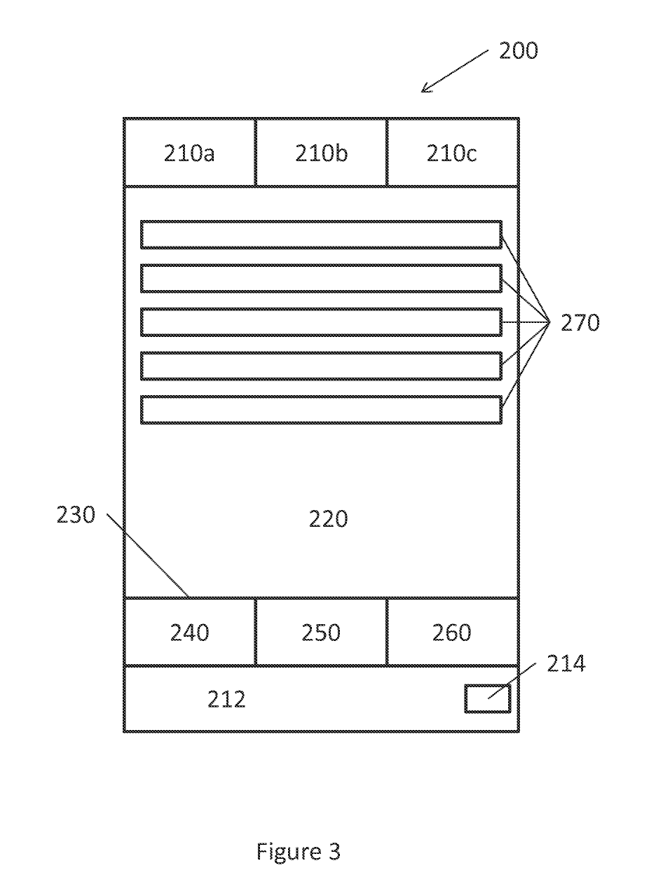

Referring to FIG. 3, a schematic representation of a portable computing device displaying a program according to embodiments of the present disclosure is shown. In FIG. 2, portable computing device 200 is illustrated displaying a plurality of media categories 210, i.e., first media category 210a, second media category 210b, and third media category 210c. Portable computing device 200 further is illustrated having a content section 220. Content section 220 may be used in order to display certain media content as selected by a user. For example, if a user selects first media category 210a, content section 220 may be updated to include media from first media category 210a.

Portable computing device 200 also includes a currently playing section 212. Currently playing section 212 further includes an option selector 214. The currently playing section 212 may include functionality to display information about the media that is currently playing. Currently playing section 212 may also include functionality to pause or otherwise manipulate the media that is currently playing. Option selector 214 may include functionality to allow a user access to additional features, such as, for example, settings, equalizers, search functions, help functions, rating functions, etc.

Media manipulation program further includes a control panel 230. Control panel 230 may include various functionality such as a play button 240, a shuffle button 250, and a media selection button 260. The play button 240 may be selected by a user to play media content from one of a preselected media category 210. Similarly, the shuffle button 250 may be selected by a user to play and shuffle media content within a preselected media category 210. The media selection button 260 may be selected in order to specifically select particular media content. Media selection button 260 may thus be selected by a user to bypass the media categories 210 during media selection.

In this embodiment, media manipulation program is illustrated after a user has selected a particular media category 210, i.e., the artist category. The artist category may include a list of various artists 270. The information shown may include, for example, an artist name, a compilation name, the number of albums available for each artist, etc.

When a user selects the artist category and content section 220 is updated with various artist information 270 the user has several options. The user may select a particular artist 270 and play media content. The user may alternatively choose the shuffle option 250. If a user then selects the shuffle option, the media manipulation program may randomly choose an artist and play that artist's songs. Additionally, the media manipulation program may generate a playlist from the artist category. The media manipulation program may then play all media in the generated playlist to completion. In certain embodiments, the shuffle option may thus be selected by a user such that media manipulation program randomly selects an artist.

During application of the shuffle option 250, a categorical unit may also be applied to define the order of playing media for a particular shuffle. For example, in the media category 210 artist, media manipulation program may apply a categorical unit of alphabetic. During shuffling, the media manipulation program would first randomly select a letter, for example, the letter “A” may be selected. Media manipulation program would then play media by artists whose name starts with “A” first. Media manipulation program would further play all media by artists whose name starts with “A” before moving on to artists whose name starts with another letter. In certain embodiments, after selection of a particular letter, media manipulation program may play media in alphabetic order or reverse alphabetic order thereafter. However, in other embodiments, media manipulation program may randomly select letters in no particular order. For example, the first selected letter may be “G”, followed by “B”, followed by “X”, and so on.

Examples of categorical units and secondary categorical units may include album name, year, genre, subject, time, length, etc. The specific categorical units defined above are not limiting, rather, are intended merely as examples of the types of categorical units the media manipulation program may apply or may be defined by a user.

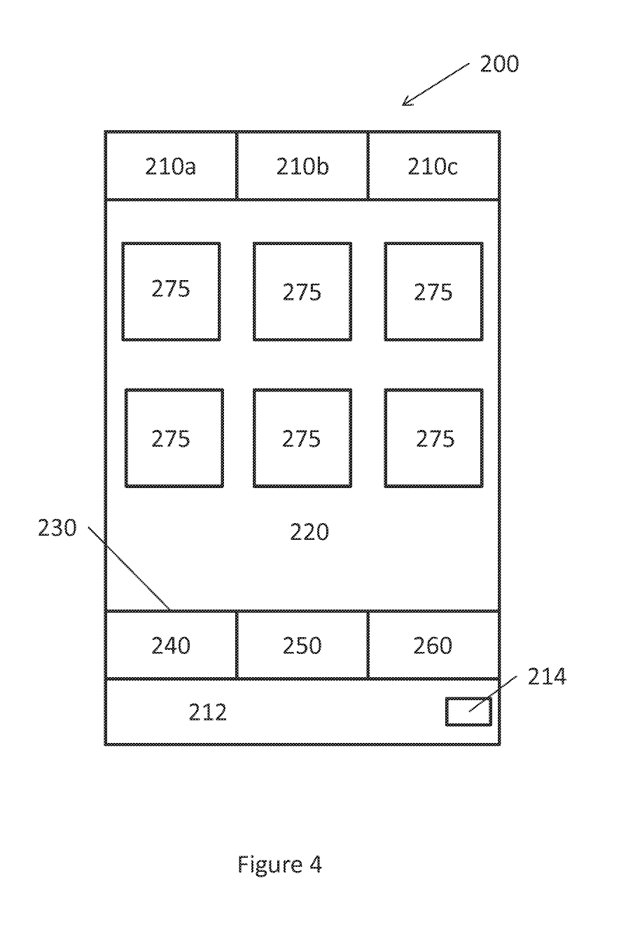

Referring to FIG. 4, a schematic representation of a portable computing device displaying a program according to embodiments of the present disclosure is shown. In FIG. 2, portable computing device 200 is illustrated displaying a plurality of media categories 210, i.e., first media category 210a, second media category 210b, and third media category 210c. Portable computing device 200 further is illustrated having a content section 220. Content section 220 may be used in order to display certain media content as selected by a user. For example, if a user selects first media category 210a, content section 220 may be updated to include media from first media category 210a.

Portable computing device 200 also includes a currently playing section 212. Currently playing section 212 further includes an option selector 214. The currently playing section 212 may include functionality to display information about the media that is currently playing. Currently playing section 212 may also include functionality to pause or otherwise manipulate the media that is currently playing. Option selector 214 may include functionality to allow a user access to additional features, such as, for example, settings, equalizers, search functions, help functions, rating functions, etc.

Media manipulation program further includes a control panel 230. Control panel 230 may include various functionality such as a play button 240, a shuffle button 250, and a media selection button 260. The play button 240 may be selected by a user to play media content from one of a preselected media category 210. Similarly, the shuffle button 250 may be selected by a user to play and shuffle media content within a preselected media category 210. The media selection button 260 may be selected in order to specifically select particular media content. Media selection button 260 may thus be selected by a user to bypass the media categories 210 during media selection.

In this embodiment, media manipulation program is illustrated after a user has selected a particular media category 210, i.e., the album category. The album category may include a list of various albums 275. The information shown may include, for example, an artist name, a compilation name, an album name. The albums may be organized in alphabetical order and may be depicted with particular album art representing each particular album.

When a user selects the album category and content section 220 is updated with various album information 275 the user has several options. The user may select a particular album 275 and play the selected media content. The user may alternatively choose the shuffle option 250. If a user then selects the shuffle option, the media manipulation program may randomly choose an album, playing that entire album before moving on to a different album. Additionally, the media manipulation program may generate a playlist incorporating all albums then play all albums in the generated playlist. In certain embodiments, the shuffle option may thus be selected by a user such that media manipulation program randomly selects an album and then plays the media content.

Examples of the application of a categorical unit to a shuffle option 250 with respect to the media category 210 albums are discussed in detail above. While the categorical units of alphabetic and date are specifically disclosed herein, those of ordinary skill in the art will appreciate that other categorical units may also be applied. Examples of other categorical units and/or secondary categorical units may include album name, year, genre, subject, time, length, etc. The specific categorical units defined above are not limiting, rather, are intended merely as examples of the types of categorical units the media manipulation program may apply or may be defined by a user.

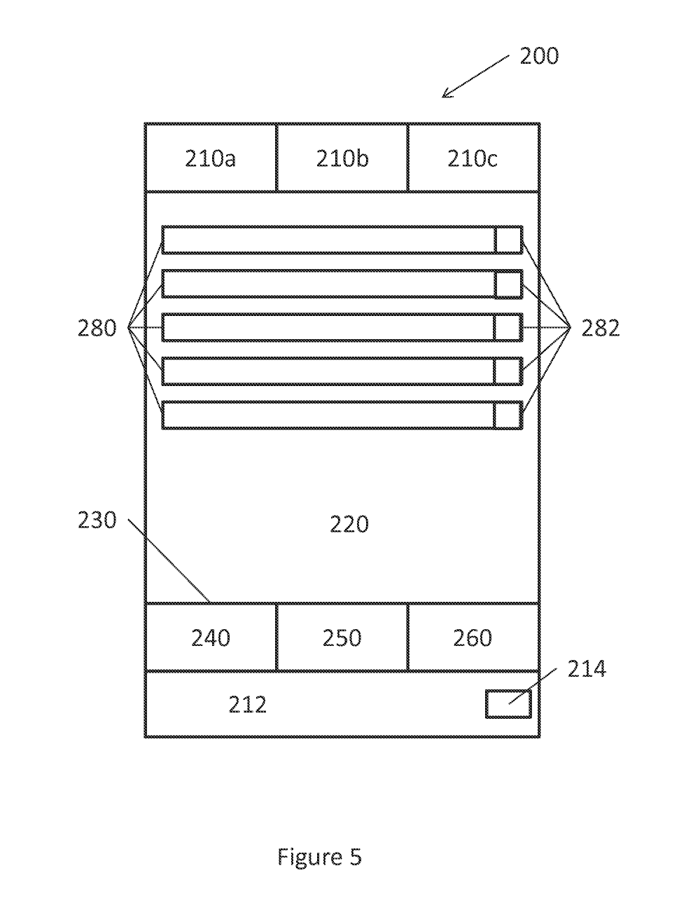

Referring to FIG. 5, a schematic representation of a portable computing device displaying a program according to embodiments of the present disclosure is shown. In FIG. 2, portable computing device 200 is illustrated displaying a plurality of media categories 210, i.e., first media category 210a, second media category 210b, and third media category 210c. Portable computing device 200 further is illustrated having a content section 220. Content section 220 may be used in order to display certain media content as selected by a user. For example, if a user selects first media category 210a, content section 220 may be updated to include media from first media category 210a.

Portable computing device 200 also includes a currently playing section 212. Currently playing section 212 further includes an option selector 214. The currently playing section 212 may include functionality to display information about the media that is currently playing. Currently playing section 212 may also include functionality to pause or otherwise manipulate the media that is currently playing. Option selector 214 may include functionality to allow a user access to additional features, such as, for example, settings, equalizers, search functions, help functions, rating functions, etc.

Media manipulation program further includes a control panel 230. Control panel 230 may include various functionality such as a play button 240, a shuffle button 250, and a media selection button 260. The play button 240 may be selected by a user to play media content from one of a preselected media category 210 in the currently sorted order. Similarly, the shuffle button 250 may be selected by a user to play and shuffle media content within a preselected media category 210. The media selection button 260 may be selected in order to specifically select particular media content. Media selection button 260 may thus be selected by a user to bypass the media categories 210 during media selection.

In this embodiment, media manipulation program is illustrated after a user has selected a particular media category 210, i.e., the song category. The song category may include a list of various songs 280. The information shown may include, for example, an artist name, a compilation name, an album name, a song time, etc. The songs may be organized in alphabetical order and may be depicted with particular album art representing each particular album. Additionally, each song may include an advanced option selector 282. Advanced option selector 212 may include the option to add information about a song, edit a tag, make the song a ringtone, delete the song, and play the song. Additionally, advanced option selection 212 may provide a second shuffle button (not specifically shown). The second shuffle button may provide substantially the same functionality as shuffle button 250. The functionality of both shuffle buttons is described in greater detail below.

When a user selects the song category and content section 220 is updated with various song information 280 the user has several options. The user may select a particular song and play the selected media content. The user may alternatively choose the shuffle option 250 or the second shuffle option described above. If a user then selects the shuffle option, the media manipulation program may randomly choose a song by a particular artist. Additionally, the media manipulation program may generate a playlist incorporating all songs then play all songs in the generated playlist. In certain embodiments, the shuffle option may thus be selected by a user such that media manipulation program randomly selects a song and then plays the media content.

During application of the shuffle option 250, a categorical unit may also be applied to group media for a particular shuffle. For example, in the media category 210 song, media manipulation program may apply a categorical unit of alphabetic. During shuffling, the media manipulation program would first randomly select a letter, for example, the letter “A” may be selected. Media manipulation program would further play all songs that have a name starting with the letter “A” before moving on to songs that start with “B.” In other embodiments, the categorical unit of date range may be applied. In certain embodiments, after selection of a particular letter, media manipulation program may play media in alphabetic order or reverse alphabetic order thereafter. However, in other embodiments, media manipulation program may randomly select letters in no particular order. For example, the first selected letter may be “G”, followed by “B”, followed by “X”, and so on.

While the categorical unit of alphabetic is specifically disclosed herein, those of ordinary skill in the art will appreciate that other categorical units may also be applied. Examples of other categorical units may include album, year, genre, subject, time, length, date, composer, a number of lines within the lyrics of a song, etc. The specific categorical units defined above are not limiting, rather, are intended merely as examples of the types of categorical units the media manipulation program may apply or may be defined by a user.

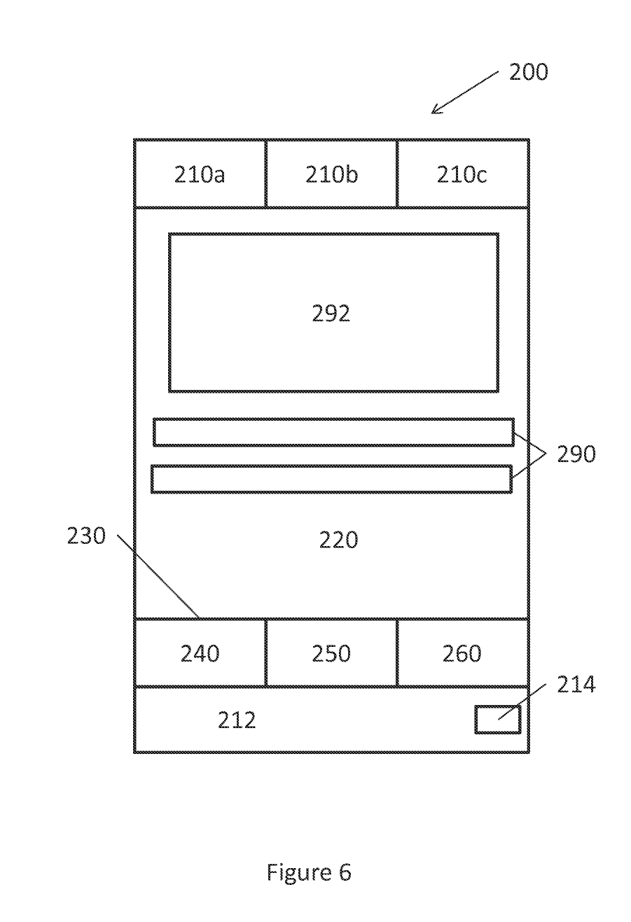

Referring to FIG. 6, a schematic representation of a portable computing device displaying a program according to embodiments of the present disclosure is shown. In FIG. 2, portable computing device 200 is illustrated displaying a plurality of media categories 210, i.e., first media category 210a, second media category 210b, and third media category 210c. Portable computing device 200 further is illustrated having a content section 220. Content section 220 may be used in order to display certain media content as selected by a user. For example, if a user selects first media category 210a, content section 220 may be updated to include media from first media category 210a.

Portable computing device 200 also includes a currently playing section 212. Currently playing section 212 further includes an option selector 214. The currently playing section 212 may include functionality to display information about the media that is currently playing. Currently playing section 212 may also include functionality to pause or otherwise manipulate the media that is currently playing. Option selector 214 may include functionality to allow a user access to additional features, such as, for example, settings, equalizers, search functions, help functions, rating functions, etc.

Media manipulation program further includes a control panel 230. Control panel 230 may include various functionality such as a play button 240, a shuffle button 250, and a media selection button 260. The play button 240 may be selected by a user to play media content from one of a preselected media category 210. Similarly, the shuffle button 250 may be selected by a user to play and shuffle media content within a preselected media category 210. The media selection button 260 may be selected in order to specifically select particular media content. Media selection button 260 may thus be selected by a user to bypass the media categories 210 during media selection.

In this embodiment, media manipulation program is illustrated after a user has selected a particular media category 210. i.e., the playlist category. The playlist category may include a list of various playlists 290 that the user has previously created. The information shown may include, for example, a playlist name, playlist content, playlist songs, playlist artists, etc. The playlist may be organized in alphabetical order and may be depicted with particular album art representing each particular playlist. Additionally, the playlist category may provide additional functionality to allow a user to access externally stored playlists. In this embodiment, the playlist category includes a sync option 292. Sync option 292 allows the user to import previously created playlists from external programs. The external programs may be on the portable computing device 200 or may be stored on other computing devices. In certain embodiments, sync option 292 may allow the user to import playlists wirelessly, while in other embodiments, sync option 292 may require a user physically connect portable computing device 200 to the external source.

When a user selects the playlist category and content section 220 is updated with various playlist information 290 the user has several options. The user may select a particular playlist and play the selected media content. The user may alternatively choose the shuffle option 250. If a user then selects the shuffle option, the media manipulation program may randomly choose a playlist. In certain embodiments, the shuffle option may thus be selected by a user such that media manipulation program randomly selects a playlist and then plays the media content of that playlist. Once completed, the next playlist will be played, and so on. Additionally, the media manipulation program may generate a playlist incorporating all playlists then play all playlists in the generated playlist.

During application of the shuffle option 250, a categorical unit may also be applied to define the order of playing media for a particular shuffle. For example, in the media category 210 playlist, media manipulation program may apply a categorical unit of alphabetic. During shuffling, the media manipulation program would first randomly select a letter, for example, the letter “A” may be selected. Media manipulation program would further play all playlists that have names starting starts with the letter “A” before moving on to playlists that have names starting with the letter “B.” In certain embodiments, after selection of a particular letter, media manipulation program may play media in alphabetic order or reverse alphabetic order thereafter. However, in other embodiments, media manipulation program may randomly select letters in no particular order. For example, the first selected letter may be “G”, followed by “B”, followed by “X”, and so on.

In other embodiments, the categorical unit of date may be applied. In such an embodiment, the media manipulation program may randomly select to play playlists based on a randomly selected date. For example, if the randomly selected date of 2005 was selected, all playlists would be played that were created in 2005 before moving on to another randomly selected date.

In still further embodiments, the categorical unit of genre may be applied to the media category 210 of playlist. In such an embodiment, the media manipulation program may randomly select a genre of playlist, and play all media within the selected genre of playlist before moving on to a second genre of playlist. For example, if the media manipulation program first selects playlists that are rock music, all playlists that are defined as including rock media will be played before moving on to playlists that encompass a different genre of music. Additionally, if multiple playlists are defined as being rock playlists, the order of play for the specific playlists may be randomly generated by the media manipulation program.

While the categorical units of alphabetic, genre, and date are specifically disclosed herein, those of ordinary skill in the art will appreciate that other categorical units may also be applied. Examples of other categorical units may include album, year, subject, time, length, date, composer, a number of lines within the lyrics of a song, etc. The specific categorical units defined above are not limiting, rather, are intended merely as examples of the types of categorical units the media manipulation program may apply or may be defined by a user.

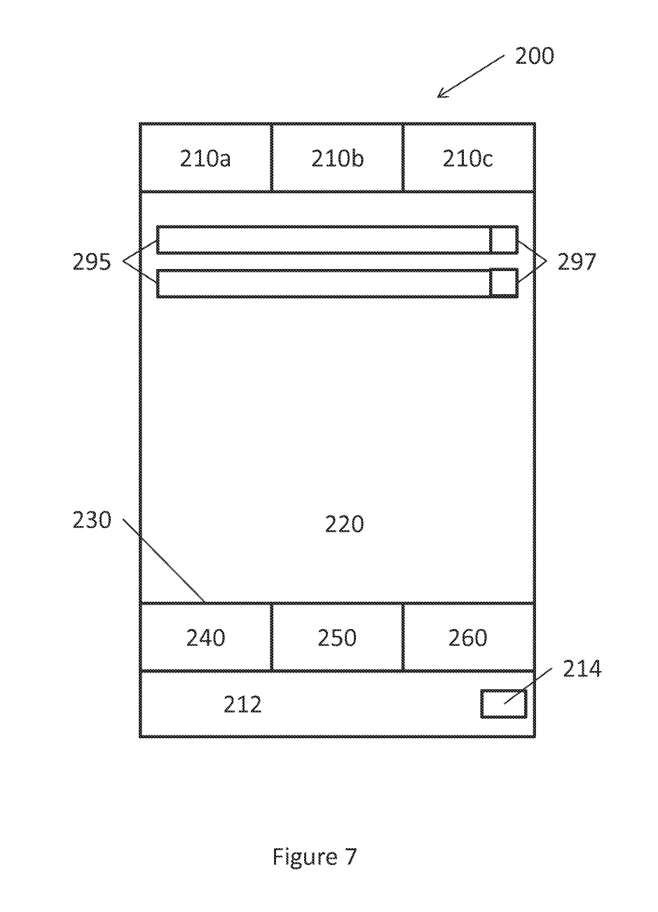

Referring to FIG. 7, a schematic representation of a portable computing device displaying a program according to embodiments of the present disclosure is shown. In FIG. 2, portable computing device 200 is illustrated displaying a plurality of media categories 210, i.e., first media category 210a, second media category 210b, and third media category 210c. Portable computing device 200 further is illustrated having a content section 220. Content section 220 may be used in order to display certain media content as selected by a user. For example, if a user selects first media category 210a, content section 220 may be updated to include media from first media category 210a.

Portable computing device 200 also includes a currently playing section 212. Currently playing section 212 further includes an option selector 214. The currently playing section 212 may include functionality to display information about the media that is currently playing. Currently playing section 212 may also include functionality to pause or otherwise manipulate the media that is currently playing. Option selector 214 may include functionality to allow a user access to additional features, such as, for example, settings, equalizers, search functions, help functions, rating functions, etc.

Media manipulation program further includes a control panel 230. Control panel 230 may include various functionality such as a play button 240, a shuffle button 250, and a media selection button 260. The play button 240 may be selected by a user to play media content from one of a preselected media category 210. Similarly, the shuffle button 250 may be selected by a user to play and shuffle media content within a preselected media category 210. The media selection button 260 may be selected in order to specifically select particular media content. Media selection button 260 may thus be selected by a user to bypass the media categories 210 during media selection.

In this embodiment, media manipulation program is illustrated after a user has selected a particular media category 210, i.e., the folder category. The folder category may include a list of various folders 295 that is available on the portable computing device 200. The information shown may include, for example, a root directory structure, a local root structure, an external root structure, a wireless root directory structure, a local medium, a temporary medium, etc. The folders may be organized in alphabetical order and/or may be depicted with particular artwork to illustrate the type of folding. Additionally, each folder may include an advanced folder option selector 297. Advanced folder option selector 297 may include the option to add information about a folder, to set equalization, to view the folder directory, to play a song from the folder, and/or to delete a folder. Additionally, advanced option selection 297 may provide a second shuffle button (not specifically shown). The second shuffle button may provide substantially the same functionality as shuffle button 250. The functionality of both shuffle buttons is described in greater detail below.

When a user selects the folder category and content section 220 is updated with various folder information 295 the user has several options. The user may select a particular folder and play media content from the folder. The user may alternatively choose the shuffle option 250 or the second shuffle option described above. If a user then selects the shuffle option, the media manipulation program may randomly choose a song by a particular artist from a randomly selected folder. Additionally, the media manipulation program may generate a playlist incorporating all media within one or more folders then play all media in the folders in the generated playlist. In certain embodiments, the shuffle option may thus be selected by a user such that media manipulation program randomly selects a song and then plays the media content.

During application of the shuffle option 250, a categorical unit may also be applied to define the order of playing media for a particular shuffle. For example, in the media category 210 folder, media manipulation program may apply a categorical unit of alphabetic. During shuffling, the media manipulation program would first randomly select a letter, for example, the letter “A” may be selected. Media manipulation program would further play all media within folder that have a name starting with the letter “A” before moving on to folders that have a name starting with the letter “B.” In other embodiments, the categorical unit of location may be applied. In such an embodiment, shuffle option 250 may only play media from within folder located in specific locations, for example, stored in a particular location on portable computing device 200.

While the categorical units of alphabetic and location are specifically disclosed herein, those of ordinary skill in the art will appreciate that other categorical units may also be applied. Examples of other categorical units may include album, year, subject, time, length, date, composer, a number of lines within the lyrics of a song, etc. The specific categorical units defined above are not limiting, rather, are intended merely as examples of the types of categorical units the media manipulation program may apply or may be defined by a user.

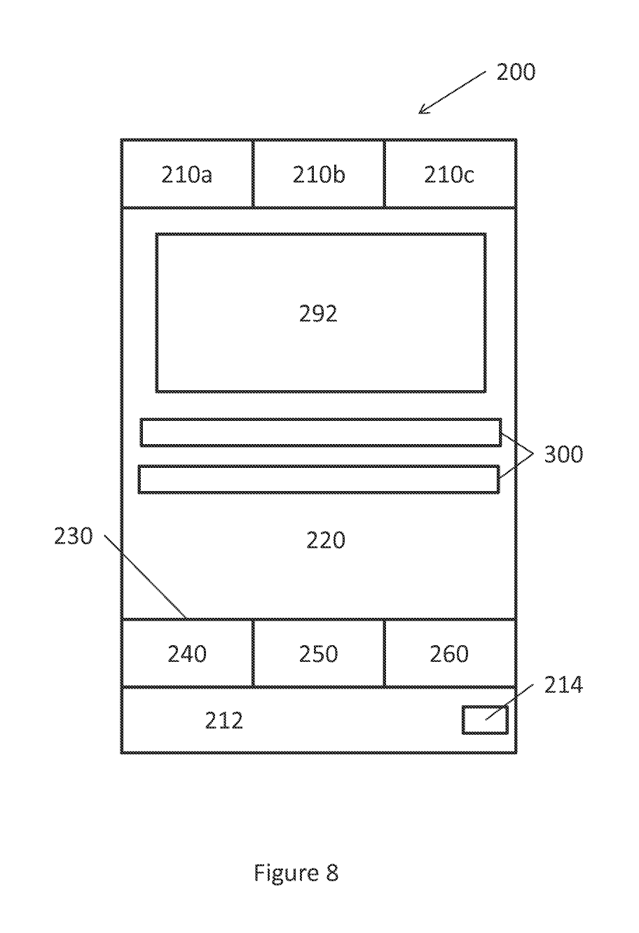

Referring to FIG. 8, a schematic representation of a portable computing device displaying a program according to embodiments of the present disclosure is shown. In FIG. 2, portable computing device 200 is illustrated displaying a plurality of media categories 210, i.e., first media category 210a, second media category 210b, and third media category 210c. Portable computing device 200 further is illustrated having a content section 220. Content section 220 may be used in order to display certain media content as selected by a user. For example, if a user selects first media category 210a, content section 220 may be updated to include media from first media category 210a.

Portable computing device 200 also includes a currently playing section 212. Currently playing section 212 further includes an option selector 214. The currently playing section 212 may include functionality to display information about the media that is currently playing. Currently playing section 212 may also include functionality to pause or otherwise manipulate the media that is currently playing. Option selector 214 may include functionality to allow a user access to additional features, such as, for example, settings, equalizers, search functions, help functions, rating functions, etc.

Media manipulation program further includes a control panel 230. Control panel 230 may include various functionality such as a play button 240, a shuffle button 250, and a media selection button 260. The play button 240 may be selected by a user to play media content from one of a preselected media category 210. Similarly, the shuffle button 250 may be selected by a user to play and shuffle media content within a preselected media category 210. The media selection button 260 may be selected in order to specifically select particular media content. Media selection button 260 may thus be selected by a user to bypass the media categories 210 during media selection.

In this embodiment, media manipulation program is illustrated after a user has selected a particular media category 210, i.e., the podcast category. The podcast category may include a list of various podcasts 3000 that the user has previously created, downloaded, and/or subscribed to. The information shown may include, for example, a podcast name, podcast content, time labels, etc. The podcasts may be organized in alphabetical order and may be depicted with particular artwork representing each particular podcast. Additionally, the podcast category may provide additional functionality to allow a user to access externally stored podcasts. In this embodiment, the podcast category includes a sync option 292. Sync option 292 allows the user to import previously created podcasts from external programs, in a same or similar manner as the importation of playlists through sync option 292 described above. The external programs may be on the portable computing device 200 or may be stored on other computing devices. In certain embodiments, sync option 292 may allow the user to import podcasts wirelessly, while in other embodiments, sync option 292 may require a user physically connect portable computing device 200 to the external source.

When a user selects the podcast category and content section 220 is updated with various podcast information 300 the user has several options. The user may select a particular podcast and play the selected media content. The user may alternatively choose the shuffle option 250. If a user then selects the shuffle option, the media manipulation program may randomly choose a podcast. Additionally, the media manipulation program may generate a playlist incorporating all podcasts then play all podcasts in the generated playlist. In certain embodiments, the shuffle option may thus be selected by a user such that media manipulation program randomly selects a podcast and then plays the media content.

During application of the shuffle option 250, a categorical unit may also be applied to define the order of playing media for a particular shuffle. For example, in the media category 210 podcast, media manipulation program may apply a categorical unit of alphabetic. During shuffling, the media manipulation program would first randomly select a letter, for example, the letter “A” may be selected. Media manipulation program would further play all podcasts that have names starting starts with the letter “A” before moving on to podcasts that have names starting with the letter “B.” In certain embodiments, after selection of a particular letter, media manipulation program may play media in alphabetic order or reverse alphabetic order thereafter. However, in other embodiments, media manipulation program may randomly select letters in no particular order. For example, the first selected letter may be “G”, followed by “B”, followed by “X”, and so on.

In other embodiments, the categorical unit of date may be applied. In such an embodiment, the media manipulation program may randomly select to play playlists based on a randomly selected date. For example, if the randomly selected date of 2005 was selected, all playlists would be played that were created in 2005 before moving on to another randomly selected date.

In still further embodiments, the categorical unit of genre may be applied to the media category 210 of podcast. In such an embodiment, the media manipulation program may randomly select a genre of podcast, and play all media within the selected genre of podcast before moving on to a second genre of podcast. For example, if the media manipulation program first selects podcasts that are comedy, all podcasts that are defined as including comedy will be played before moving on to podcasts that encompass a different genre. Additionally, if multiple podcasts are defined as being comedy, the order of play for the specific podcasts may be randomly generated by the media manipulation program.

While the categorical units of alphabetic order, date, and genre are specifically disclosed herein, those of ordinary skill in the art will appreciate that other categorical units may also be applied. Examples of other categorical units may include album, year, subject, time, length, date, composer, a number of lines within the lyrics of a song, etc. The specific categorical units defined above are not limiting, rather, are intended merely as examples of the types of categorical units the media manipulation program may apply or may be defined by a user.

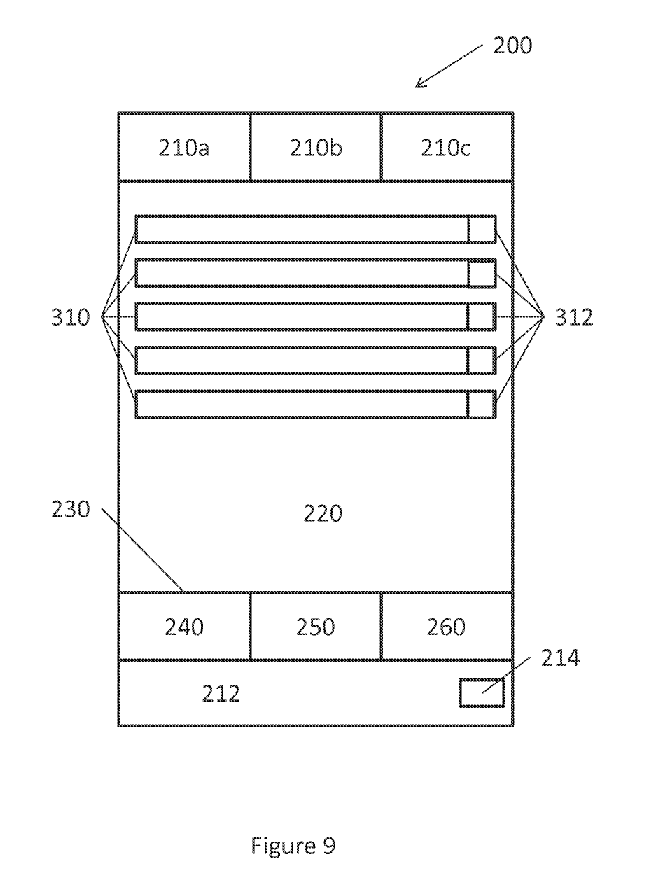

Referring to FIG. 9, a schematic representation of a portable computing device displaying a program according to embodiments of the present disclosure is shown. In FIG. 2, portable computing device 200 is illustrated displaying a plurality of media categories 210, i.e., first media category 210a, second media category 210b, and third media category 210c. Portable computing device 200 further is illustrated having a content section 220. Content section 220 may be used in order to display certain media content as selected by a user. For example, if a user selects first media category 210a, content section 220 may be updated to include media from first media category 210a.

Portable computing device 200 also includes a currently playing section 212. Currently playing section 212 further includes an option selector 214. The currently playing section 212 may include functionality to display information about the media that is currently playing. Currently playing section 212 may also include functionality to pause or otherwise manipulate the media that is currently playing. Option selector 214 may include functionality to allow a user access to additional features, such as, for example, settings, equalizers, search functions, help functions, rating functions, etc.

Media manipulation program further includes a control panel 230. Control panel 230 may include various functionality such as a play button 240, a shuffle button 250, and a media selection button 260. The play button 240 may be selected by a user to play media content from one of a preselected media category 210. Similarly, the shuffle button 250 may be selected by a user to play and shuffle media content within a preselected media category 210, keeping the grouping of the media content intact. The media selection button 260 may be selected in order to specifically select particular media content. Media selection button 260 may thus be selected by a user to bypass the media categories 210 during media selection.

In this embodiment, media manipulation program is illustrated after a user has selected a particular media category 210, i.e., the genres. The genres category may include a list of various genres 310 of music. Examples of genres of music that may be displayed include, for example, alternative, blues, country, dance, folk, metal, pop, rap, trance, etc. The genres may be organized in alphabetical order and may be depicted with particular art representing each genre. Additionally, each genre may include an advanced genre option selector 312. Advanced option selector 312 may include the option to add information about a genre, set genre equalization, view songs in the genre, play a particular genre, and/or delete a particular genre. Additionally, advanced option selection 212 may provide a second shuffle button (not specifically shown). The second shuffle button may provide substantially the same functionality as shuffle button 250. The functionality of both shuffle buttons is described in greater detail below.

When a user selects the genre category and content section 220 is updated with various genres information 280, such as songs or artists that represent the genre, the user has several options. The user may select a particular genre and play the selected media content. The user may alternatively choose the shuffle option 250 or the second shuffle option described above. If a user then selects the shuffle option, the media manipulation program may randomly choose a single genre and play that genre to exhaustion and proceed to the next random genre. Additionally, the media manipulation program may generate a playlist incorporating all genres, then play all genres in the generated playlist. In certain embodiments, the shuffle option may thus be selected by a user such that media manipulation program randomly selects a song and then plays the media content based on either a randomly selected genre or based on a user selected genre. In the case of the former, shuffle button 250 may be selected by the user. In the case of the former, when the user wishes to play media from a particular genre, the second shuffle button may be selected by the user after selected a desired genre.

During application of the shuffle option 250, a categorical unit may also be applied to define the order of playing media for a particular shuffle. For example, in the media category 210 genre, media manipulation program may apply a categorical unit of alphabetic. During shuffling, the media manipulation program would first randomly select a letter, for example, the letter “A” may be selected. Media manipulation program would further play all media from a genre that has a name starting with the letter “A” before moving on to media from genres that have names starting with the letter “B.” In certain embodiments, after selection of a particular letter, media manipulation program may play media in alphabetic order or reverse alphabetic order thereafter. However, in other embodiments, media manipulation program may randomly select letters in no particular order. For example, the first selected letter may be “G”, followed by “B”, followed by “X”, and so on.

While the categorical unit of alphabetic is specifically disclosed herein, those of ordinary skill in the art will appreciate that other categorical units may also be applied. Examples of other categorical units may include album, year, subject, time, length, date, composer, a number of lines within the lyrics of a song, etc. The specific categorical units defined above are not limiting, rather, are intended merely as examples of the types of categorical units the media manipulation program may apply or may be defined by a user.

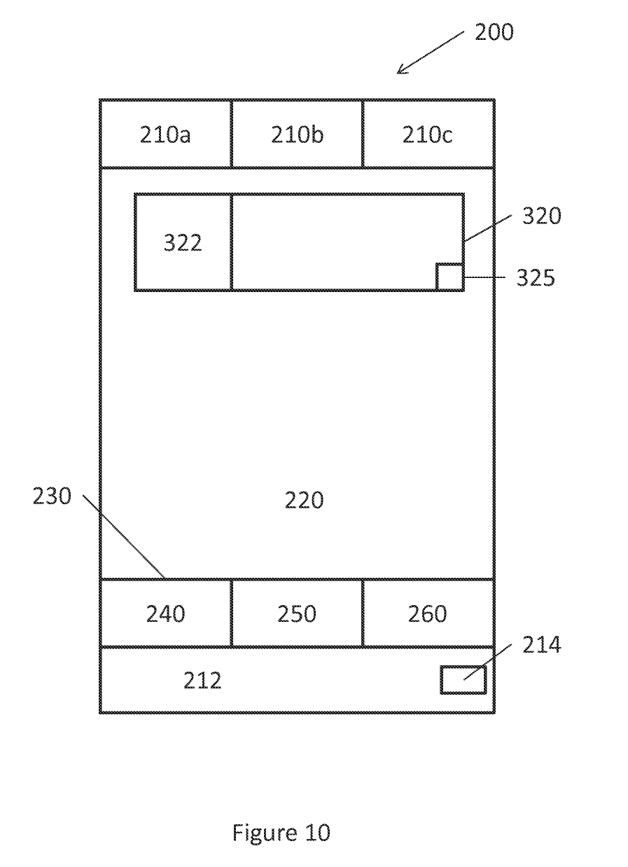

Referring to FIG. 10, a schematic representation of a portable computing device displaying a program according to embodiments of the present disclosure is shown. In FIG. 2, portable computing device 200 is illustrated displaying a plurality of media categories 210, i.e., first media category 210a, second media category 210b, and third media category 210c. Portable computing device 200 further is illustrated having a content section 220. Content section 220 may be used in order to display certain media content as selected by a user. For example, if a user selects first media category 210a, content section 220 may be updated to include media from first media category 210a.

Portable computing device 200 also includes a currently playing section 212. Currently playing section 212 further includes an option selector 214. The currently playing section 212 may include functionality to display information about the media that is currently playing. Currently playing section 212 may also include functionality to pause or otherwise manipulate the media that is currently playing. Option selector 214 may include functionality to allow a user access to additional features, such as, for example, settings, equalizers, search functions, help functions, rating functions, etc.

Media manipulation program further includes a control panel 230. Control panel 230 may include various functionality such as a play button 240, a shuffle button 250, and a media selection button 260. The play button 240 may be selected by a user to play media content from one of a preselected media category 210. Similarly, the shuffle button 250 may be selected by a user to play and shuffle media content within a preselected media category 210. The media selection button 260 may be selected in order to specifically select particular media content. Media selection button 260 may thus be selected by a user to bypass the media categories 210 during media selection.

In this embodiment, media manipulation program is illustrated after a user has selected a particular media category 210, i.e., the video category. The video category may include a list of various videos 320 that is available on the portable computing device 200. Each video may have a video preview 322, which shows a still scene from the video prior to selection. Additionally, each video may include an advanced video option selector 325. Advanced video option selector 325 may include the option to add information about a video, play a video, delete a video, etc.

When a user selects the video category and content section 220 is updated with various video information 320 the user has several options. The user may select a particular video and play media content. The user may alternatively choose the shuffle option 250. If a user then selects the shuffle option, the media manipulation program may randomly choose a video, then play all videos until all videos have been played. Additionally, the media manipulation program may generate a playlist incorporating all videos then play all videos in the generated playlist. In certain embodiments, the shuffle option may thus be selected by a user such that media manipulation program randomly selects a video and then plays the media content.

During application of the shuffle option 250, a categorical unit may also be applied to define the order of playing media for a particular shuffle. For example, in the media category 210 video, media manipulation program may apply a categorical unit of alphabetic. During shuffling, the media manipulation program would first randomly select a letter, for example, the letter “A” may be selected. Media manipulation program would further play all videos that have a name starting with the letter “A” before moving on to videos that have a name starting with the letter “B.” In certain embodiments, after selection of a particular letter, media manipulation program may play media in alphabetic order or reverse alphabetic order thereafter. However, in other embodiments, media manipulation program may randomly select letters in no particular order. For example, the first selected letter may be “G”, followed by “B”, followed by “X”, and so on.

In other embodiments, the categorical unit of date range may be applied. In such an embodiment, the media manipulation program may randomly select to play videos based on a randomly selected date. For example, if the randomly selected date of 2005 was selected, all videos would be played that were created/released in 2005 before moving on to another randomly selected date.

While the categorical units of alphabetic and date are specifically disclosed herein, those of ordinary skill in the art will appreciate that other categorical units may also be applied. Examples of other categorical units may include album, year, subject, time, length, date, composer, a number of lines within the lyrics of a song, etc. The specific categorical units defined above are not limiting, rather, are intended merely as examples of the types of categorical units the media manipulation program may apply or may be defined by a user.

During operation of the media manipulation program in accordance with embodiments described above a user may select and the media manipulation program execute specific operations. In one embodiment, in manipulating media content on a portable computing device, a user may cause the program to identify a selection of a category of media. Examples of categories of media that may be selected between include an artist, an album, a song, a playlist, a folder, a podcast, a genre, and a video.

After identifying a selection of a category of media, the media manipulation program identifies media content for the selected category of media and displays the media content on the portable computing device. After the media content is identified, the user may cause the program to activate a shuffle option for the specific category of media. Rather than shuffle between all songs on the portable computing device, the category specific shuffle option allows the program to shuffle media from the specific selected category, as described in detail above.

If the shuffle option is activated, the program plays media content randomly from the identified selected category of media. For example, if the user selects the artist category, the program plays media based on a random shuffling of artists. Similarly, if the user selects the shuffle option after identifying the album category, the program plays a randomly selected album. If the user selects the shuffle option after identifying the song category, the program plays a song randomly selected song from the directory of information linked to the song category in the program. If the user selects the shuffle option after identifying the playlist category, the program plays each playlist in order, but randomly picks which playlists to play. If the user selects the shuffle option after identifying the folder category, the program plays a randomly selected media from a randomly selected folder, then moves on to the next random folder. If the user selects the shuffle option after identifying the podcast category, the program plays a randomly selected podcast series, and moves to the next random podcast series. If the user selects the shuffle option after identifying the genre category, the program plays a randomly selected song, artist, or album that is associated with a particular genre, once exhausted, it moves to the next random genre. If a particular genre isn't selected, a randomly selected genre of music is selected by the program and media content associated with the randomly selected genre is played. If the user selects the shuffle option after identifying the video category, the program plays a randomly selected video.

If after selecting to shuffle a first media category the user wishes to change the type of shuffle, the user can simply select a different, e.g., second category and select the shuffle option. Selecting the shuffle option a second time will randomly select media from the second media category the same as described above with respect to the first selected shuffled media category.

In certain embodiments, activation of the shuffle option causes the media manipulation program to randomly select media from within a media category. In other embodiments, activation of the shuffle option causes the media manipulation program to generate a playlist from media within the selected media category. In both embodiments, all media is played within the selected media category without further input from the user. In certain embodiments, the user may interrupt the playing of the media from the selected media category. If the user interrupts the playing of shuffled media, the generated playlist for a specific category may either be saved by the program as a playlist or otherwise removed from the device memory. If the generated playlist is not saved, reactivation of the shuffle option will either begin random playing of media in the selected category or otherwise generate a new playlist incorporating all media from the selected media category.

In still other embodiments, upon activation of the shuffle option the media manipulation program may generate a playlist of all media within a media category. The user may then actively select media from the generated playlist. In such an embodiment, the generated playlist may be saved on the device and viewed by the user through, for example, the control panel (discussed in detail above). In the event the generated playlist is viewable by the user, the user may actively select or remove media from the selected media category from the generated playlist.

In certain embodiments, media manipulation program may apply a categorical unit to a selected media category. In such embodiments, a categorical unit is applied to the particular media category and media content within the media category is shuffled according to the definitions of the categorical unit. Additionally, multiple levels of categorical units may be applied to further define the parameters of the media that is played. Furthermore, the categorical unit may be selected and applied by media manipulation program or may be user defined. Thus, a user may select a specific categorical unit to apply to a particular shuffle function, the media manipulation program may randomly select a categorical unit to apply to a particular shuffle function, or the media manipulation program may apply a specific categorical unit to a particular shuffle function. Upon application of a categorical unit to a shuffle function, the media manipulation may play all media within the media category that are grouped by the categorical unit criteria randomly. In certain embodiments, the categorical unit may be used to expressly exclude some media content from within a particular media category, while in other embodiments, all media from within the selected media category will be played.

In certain embodiments, instructions to execute the method described above may be stored on a non-transitory computer readable medium. Non-transitory computer readable media includes all media types except for transitory media, i.e., a propagating signal.

In still further embodiments, a portable computing device may include a touch screen display, one or more processors, memory, and one or more programs. The programs may be stored in the memory and be executed by one or more of the processors. One program that may be stored and executed the media manipulation program described above, in which the program has instructions for selecting a category of media and instructions for identifying media content for the selected category of media. The program also includes instructions for selecting a shuffle option for the category of media and instructions for playing the media content for the selected category of media.

Advantageously, embodiments of the present disclosure may provide for programs that randomly select media content from a predefined category of media. Such programs may be executed on portable computing devices such as dedicated media players and cellphones.

Also advantageously, embodiments of the present disclosure may provide for advanced shuffle options that allow a user to shuffle media according to a preselected category. For example, a user may have a program randomly select media content from a predefined type of media, e.g., song, artist, album, video, etc.

Also advantageously, embodiments of the present disclosure may provide for media manipulation that provides customizable shuffling options, thereby allowing a user to more completely control the type of media that is randomly selected. For example, rather than have a program select from the entire universe of media stored in a selected location or on a selected device, the user may define the universe of randomly selected media. The program may then randomly select media content to play from the defined universe of media type.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A computer implemented method, the method comprising:
identifying a selection of a media category;
identifying media content for the selected media category;
activating a shuffle option for the media category;
applying a categorical unit to the media category; and
playing the media content for the selected media category based on the applied categorical unit.

2. The method of claim 1 further comprising identifying a second selection of a media category, selecting the shuffle option for the second media category, and playing the media content for the second selected media category.

3. The method of claim 1, wherein the shuffle option is displayed statically on the portable computing device.

4. The method of claim 1, wherein the playing the media content is played randomly from within the selected media category based on the applied categorical unit.

5. The method of claim 2, wherein the activating the shuffle option for the second media category plays the media content randomly from within the second selected media category.

6. The method of claim 1, wherein the media category is selected from at least two of a group of categories consisting of an artist, an album, a song, a playlist, a folder, a podcast, a genre, and a video.

7. The method of claim 1, wherein activating the shuffle option comprises generating a playlist for the media category, and the playing the media comprises playing the media from the generated playlist.

8. The method of claim 1, wherein the playing the media content comprises playing all media within the selected media category.

9. The method of claim 1, further comprising applying a secondary categorical unit to the media category.

10. The method of claim 9, wherein the playing the media content for the selected media category comprises playing media content based on the applied categorical unit and the applied secondary categorical unit.

11. The method of claim 1, wherein the categorical unit comprises at least one selected from a group consisting of an alphabetic, a date, an album, a year, a subject, a time, a length, a date, a composer, and a number of lines within the lyrics.

12. The method of claim 9, wherein playing the media content comprises randomly selecting media content based on at least one of the categorical unit and the secondary categorical unit.

13. A non-transitory computer-readable medium comprising software instructions that, when executed by a processor, performs a method comprising:
identifying a selection of a media category;
identifying media content for the selected media category;
activating a shuffle option for the media category;
applying a categorical unit to the media category; and
playing the media content for the selected media category.

14. The computer-readable medium of claim 13, further comprising identifying a second selection of a media category, activating the shuffle option for the second category of media, and playing the media content for the second selected media category.

15. The computer-readable medium of claim 13, wherein the shuffle option is displayed statically on the portable computing device.

16. The computer-readable medium of claim 13, wherein the activating the shuffle option plays the media content by selected organization randomly.

17. A computing device comprising:
a display:
a processor;
a memory; and
one or more programs, wherein the one or more programs are stored in the memory and configured to be executed by the one or more processors, the one or more programs including:
instructions for identifying a selection of a media category;
instructions for identifying media content for the selected media category;
instructions for activating a shuffle option for the media category;
instructions for applying a categorical unit to the media category; and
instructions for playing the media content for the selected media category.

18. The computing device of claim 17, further comprising instructions for identifying a selection of a second media category, selecting the shuffle option for the second media category, and playing the media content for the second selected media category.

19. The method of claim 17, wherein the shuffle option is displayed statically on the portable computing device.

20. The method of claim 17, wherein the activating the shuffle option plays the media content randomly from within the selected media category.
